(19) United States
(12) Patent Application Publication
(10) Pub. No.: US 2010/0116240 A1
(43) Pub. Date: May 13, 2010

(54) MULTI-PIECE THIN WALLED POWDER METAL CYLINDER LINERS

(75) Inventors: Timothy M. Campbell, Hartland, WI (US); Joel H. Mandel, Hartford, WI (US); Donald J. Phillips, Menomonee Falls, WI (US); Donald D. Cooper, Fond du Lac, WI (US)

Correspondence Address: QUARLES & BRADY LLP, 411 E. WISCONSIN AVENUE, SUITE 2040, MILWAUKEE, WI, 53202-4497, US

(73) Assignee: GKN SINTER METALS, LLC., Aubum Hills, MI (US)

(21) Appl. No.: 12/532,588

(22) PCT Filed: Apr. 3, 2008
(86) PCT No.: PCT/US2008/059207

§ 371 Date: Sep. 22, 2009

Related U.S. Application Data
(60) Provisional application No. 60/910,100, filed on Apr. 4, 2007.

(51) Int. Cl. F02F 1/00; B23P 11/00

(52) U.S. Cl. 123/193.2; 29/888.061

(57) ABSTRACT

A powder metal cylinder liner with a ratio of the length to the wall thickness greater than 12 made of at least two end to end cylinder liner pieces with each piece having a ratio of the length to the wall thickness of less than 20. The powder metal composition includes approximately between 85% and 99% sponge iron powder, approximately between 0.1% and 2.0% graphite, and approximately between 0.1% and 2.0% ethylene bis-stearamide wax. The cylinder liner pieces can be made using conventional powder metal compaction and sintering processes.

### CROSS REFERENCE TO RELATED APPLICATION

This claims the benefit of U.S. Provisional Patent Application No. 60/910,100 filed Apr. 4, 2007, which is hereby incorporated by reference.

### FIELD OF THE INVENTION

This invention relates to sintered powder metal manufacturing and in particular to powder metal cylinder liners for an internal combustion engine.

### BACKGROUND OF THE INVENTION

The use of sintered powder metal (PM) parts has accelerated in the recent past for components difficult to manufacture by other methods as PM components can offer a cost effective alternative to other metal formed components. Some advantages of powder metallurgy include lower costs, improved quality, increased productivity and greater design flexibility. These advantages are achieved in part because PM parts can be manufactured to net-shape or near-net shape which yields little material waste, and which in turn eliminates or minimizes machining. Other advantages of the PM manufacturing process and parts produced there from, particularly over other metal forming processes, include greater material flexibility including graded structures or composite metal, lighter weight of the parts, greater mechanical flexibility, reducing energy consumption and material waste in the manufacturing process, high dimensional accuracy of the part, good surface finish of the part, controlled porosity for self-lubrication or infiltration, increased strength and corrosion resistance of the component, and low emissions, among others.

Internal combustion engine manufacturers have sought more efficient, cost effective and viable ways to reduce cost and weight in engines without sacrificing performance and/or safety. One of the largest and most important components of the engine is the cylinder block. In the past, cylinder blocks had been formed from cast iron, which provided strength, durability and long service life. However, as can be appreciated, cast iron is quite heavy. Further, cast iron has a relatively poor thermal conductivity. Consequently, alternatives to cast iron cylinder blocks are sought.

One such alternative is to form the blocks from aluminum alloy. Aluminum alloy is very lightweight and has good thermal conductivity, each of which are desirable features in the engine industry. However, aluminum alloy is relatively soft and easily scratched and thus does not provide the strength, durability and long service life required for use in a cylinder block, particularly with respect to the requirements of the cylinder bores in the block. Further, aluminum alloy has a relatively high coefficient of thermal expansion compared to iron, which can increase blowby between a cylinder and piston during combustion at high operating temperatures, thereby increasing emissions.

As an alternative, engine manufacturers have used more wear resistant cylinder liners within the cylinder bores of an aluminum block. Cylinder liners are typically in-cast into aluminum engine blocks to provide improved wear resistance compared to the aluminum bore that is present without the liner. A cast iron, machined cylinder liner is typically used for engines that require a cylinder liner. However, these cast iron cylinder liners have a less than desirable mechanical bond with the aluminum engine block which leads to less than desirable heat transfer properties. Further, features are required on the outside of the cast iron cylinder liner to “lock” in place in the aluminum block, and these features can create an uneven heat transfer from the cast iron cylinder liner to the aluminum block, or undesirable voids or local hot spots can be created between the liner and the aluminum. Additionally, the alloys used in cast iron cylinder liners are not optimum relative to strength and stiffness, resulting in bore distortion during combustion, more blow-by and higher emissions.

The inherent porosity of a powder metal iron alloy part, when in-cast into an aluminum casting, allows the molten aluminum to infiltrate the matrix of the PM part to improve the bond between the surrounding aluminum alloy and the PM part. Allowing penetration of the molten aluminum alloy into the cylinder liner porosity also takes advantage of the desirable machinability of the impregnated PM matrix.

Although PM technology has the potential of overcoming some of the problems with cast iron cylinder liners, production of PM cylinder liners by conventional compaction to net shape or near net shape has not been commercially feasible. One reason is that the high length to wall thickness ratio results in excessive difficulties filling the compaction die with metal powder. In addition, compacting from the ends of a part with a high aspect ratio results in an unacceptable density gradient along the length of the cylinder liner, and inadequate green strength of the compact. These problems can be somewhat overcome using cold isostatic compaction plus subsequent secondary manufacturing operations, but can be too costly in comparison with cast cylinder liners.

### SUMMARY OF THE INVENTION

The present invention provides a cylinder liner construction that can be used to make cylinder liners having a high length to wall thickness ratio, out of powder metal. The liner is made of multiple powder metal cylinder liner pieces, placed end to end coaxially, to form the cylinder liner.

In one aspect, the invention provides a cylinder liner that has a powder metal composition formed into a cylinder, where the cylinder includes a wall thickness and a length, and a ratio of the length to the thickness is greater than 12. Each piece, on the other hand, would typically have a ratio of less than 20.

In another aspect, the invention provides an internal combustion engine that has an engine block with at least one combustion cylinder liner of the invention.

An advantage of the present invention is being able to make a low density powder metal cylinder liner (e.g., nominally 6.3 g/cc) to improve the bond between the surrounding aluminum alloy and the cylinder liner by allowing penetration of the molten aluminum alloy into the cylinder liner PM matrix porosity.

Another advantage of the present invention is that the resulting improvement in bonding reduces or eliminates the need for outside diameter features, and improves uniformity of heat transfer from the combustion chamber to the surrounding aluminum.

Another advantage of the present invention is providing a powder metal component that has acceptable density, and preferably relatively uniform density, along the length of the wall from end to end.

Another advantage is being able to make the sintered powder metal liner pieces to near their final machined thickness, to reduce subsequent machining operations and material waste.

The present invention provides the advantages discussed above relative to sintered powder metal cylinder liners.

The foregoing and other advantages of the invention appear in the detailed description which follows. In the description, reference is made to the accompanying drawings which illustrate a preferred embodiment of the invention.

### BRIEF DESCRIPTION OF THE DRAWINGS

FIG. 1 is a cross-sectional view of a cylinder of an internal combustion engine with a cylinder liner of the invention cast in place;

FIG. 2 is a cross-sectional view of a cylinder liner of the invention illustrated apart from the cylinder of the engine;

FIG. 3 is a detail cross-sectional view of the joint between the two ends of the two cylinder pieces that make up the cylinder liner of FIGS. 1 and 2; and

FIG. 4 is a cross-sectional view of one of the cylinder liner pieces apart from the other piece that makes up the liner of FIGS. 1-3.

### DETAILED DESCRIPTION OF THE PREFERRED EMBODIMENT

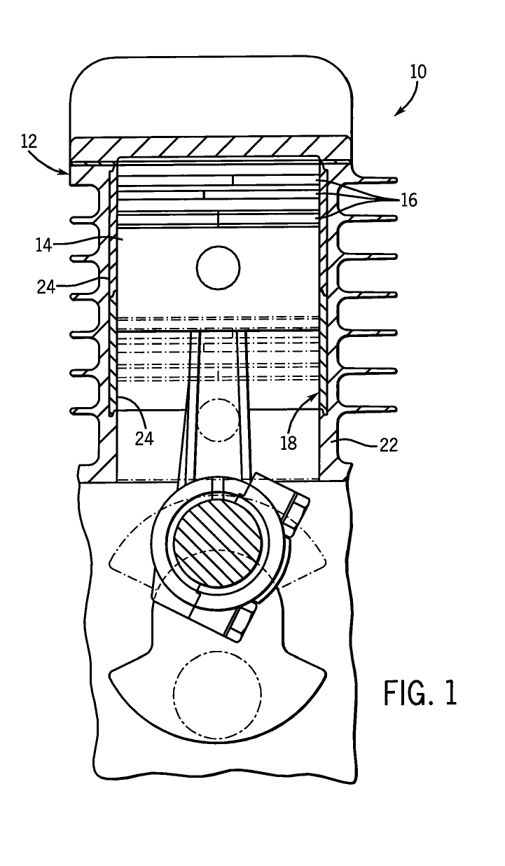

Referring to FIG. 1, an internal combustion engine 10 has a combustion cylinder 12 that is made by casting aluminum alloy 22 around the outside of a sintered powder metal cylinder liner 18. The aluminum alloy 22 infiltrates pores in the liner 18 to hold it firmly. A piston 14 with rings 16 reciprocates in the cylinder as the engine operates.

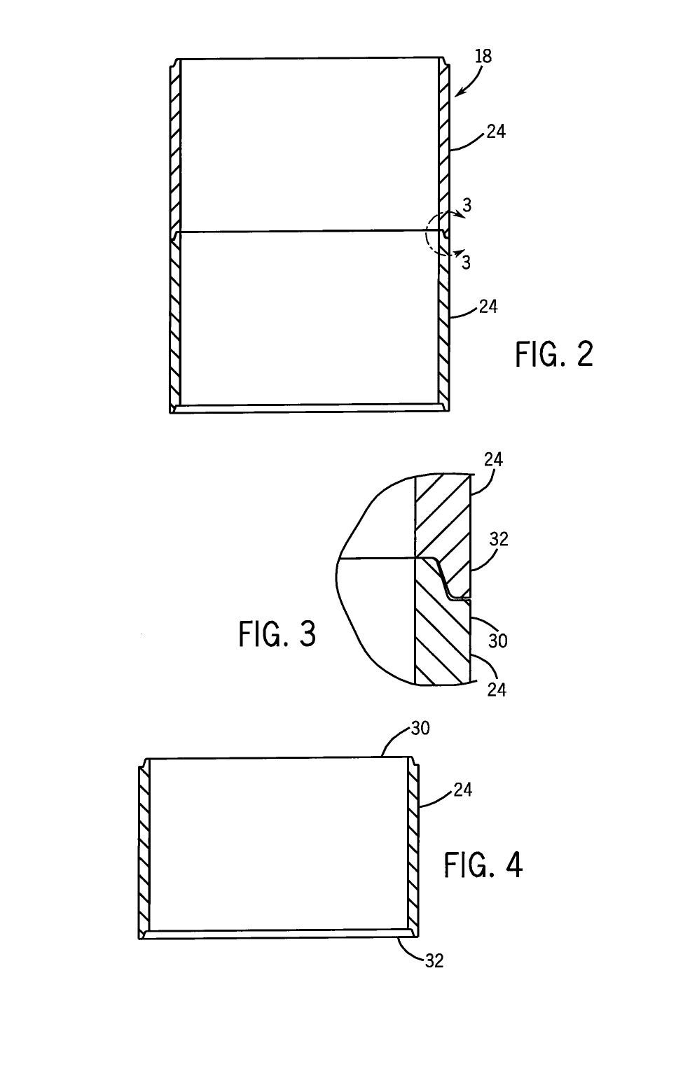

The liner 18 is made of two cylinder liner pieces 24, which are cylinders of the same general shape as the liner 18, but shorter. The two pieces 18 are placed end to end coaxially, preferably so that their ends abut. Preferably, as illustrated in FIG. 2, the ends are stepped, with mating male 30 and female 32 ends. As illustrated in FIG. 2, the bottom (female) end of the upper piece 24 fits around and mates closely with the upper (male) end of the lower piece 24. As illustrated in FIG. 3, at the outer edge of the joint, a small gap, e.g., 0.050 at the edge, is created to permit brazing material to infiltrate the gap to hold the two pieces. The brazing may be sinter brazing, i.e., brazing that is performed during the sintering process, or post-sinter brazing. Alternatively, it may not be necessary to affix or bond the pieces 24 to one another prior to casting them into the cylinder 12, if for example they are placed on a core rod or other device to align and abut them end to end and then affixed to one another by the aluminum alloy 22 during the cylinder casting process, or they could be press fit to one another prior to casting into the cylinder 12, and then cast into the cylinder.

Conventional powder metal compaction and sintering processes can be used to make each piece 24. The die cavity would have the shape of one of the pieces 24, filling would be from the top, and compaction may be from both ends. Further, in a conventional powder metal compaction operation, for a part with a high aspect ratio, there would typically be density variations in the wall of the part along the length, with higher densities at the ends than at the middle of the part. By making each piece 24 shorter than the whole liner 18, density thoughout the part is made more uniform.

The powder metal composition of the pieces 24 can include approximately between 85% and 99% sponge iron powder, approximately between 0.1% and 2.0% graphite, and approximately between 0.1% and 2.0% a synthetic wax such as ethylene bis-stearamide wax (synonymous with N, N′ethylene bis-stearamide; N, N′distearoylethyelendiamine; EBS). More specifically, powder metal composition 34 can include approximately 98.1% sponge iron powder, approximately 0.9% graphite, and approximately 1.0% ethylene bis-stearamide wax. Sponge iron powder results from the direct reduction of high grade magnetite iron ore. This process results in spongy particles (as viewed in photomicrographs, for example) which have good compressibility, exceptionally good green strength and produces parts with good edge integrity. Ancor MH-100 is an example of such a sponge iron powder.

The synthetic wax powder is used as a lubricant and binder for the compaction of powdered metal parts, such as Acrawax® lubricant. The graphite is a high quality powder graphite for sintering and alloy control, such as Asbury 3203 graphite. Powder metal composition 34 can additionally include up to 0.5% phosphorus.

Powder metal cylinder liner 22 consequently has a relatively uniform density along the length of the cylinder liner 18. The density can be approximately between 5.8 g/cm³ and 6.8 g/cm³, and more specifically, the density is approximately 6.3 g/cm³. Prior to machining the inside diameter, the wall thickness 50 may be, for example, just slightly more than the post machining thickness, for example each piece 24 may have an ID of 2.608 inches and an OD of 2.818. The machining operation may only remove about 2-10% of the wall thickness, or no machining may be necessary prior to casting the liner 18 into the cylinder block. Length of the liner 18 may be 3.582 inches for the whole liner, with a length of approximately half of that for each piece 24. More than two pieces could be used to produce a liner, but acceptable filling, compaction and density uniformity will be possible in many cases with just two pieces 24. The cylinder liner 18 can have a ratio of length to wall thickness 50 greater than 12, and the same ratio for each piece 24 should be less than 20. Also, preferably the wall thickness of the powder metal compact of each piece 24 (prior to sintering or any machining) should have a wall thickness of less than 0.20 inches.

The green compact powder metal cylinder liner pieces 24, either alone or put together, typically requires sintering at an elevated temperature to strengthen them, as is well known. It's possible however that the sintered part could be made so near net shape that the machining step prior to in-casting could be eliminated, with the only machining being done after the sintered PM liner 18 is cast into the cylinder 12.

FIG. 1 illustrates an internal combustion engine 10 according to the present invention which includes a cylinder 12 with at least one combustion cylinder bore having therein piston 14, and at least one cylinder liner 18. Internal combustion engine 10 can include other elements such as a fuel system, crankshaft, lubrication system, cooling system and other elements as are known. As stated, the cylinder bore defined by cylinder liner 18, the aluminum alloy that impregnates it and the surrounding aluminum of the cylinder may require additional machining after the liner is cast into the cylinder 12.

The liner 18 should be long enough so that at bottom dead center of the piston 14, all of the rings 16 of the piston are axially overlapping the liner 18, as they should also be overlapping at top dead center of the piston 14.

A preferred embodiment of the invention has been described in considerable detail. Many modifications and variations to the preferred embodiment described will be apparent to a person of ordinary skill in the art. Therefore, the invention should not be limited to the embodiments described.

We claim:

1. In a cylinder liner for an internal combustion engine, the cylinder liner being made of a ferrous sintered powder metal and being castable into a cylinder wall of an internal combustion engine in which at least a portion of the cylinder surrounding the liner is an aluminum alloy, the improvement wherein the cylinder liner comprises at least two cylinder liner pieces which when cast into the cylinder wall are coaxial.

2. A cylinder liner as in claim 1, wherein ends of the cylinder liner pieces are stepped to mate with each other in an end to end connection.

3. A cylinder liner as in claim 1, wherein the liner pieces are brazed together.

4. A cylinder liner as in claim 3, wherein the brazing of the pieces together is performed during sintering.

5. A cylinder liner as in claim 1, wherein the ratio of the length to wall thickness of the liner is greater than 12 and the ratio of the length to wall thickness of each cylinder liner piece is less than 20.

6. A cylinder liner as in claim 1, wherein less than 10% of the wall thickness of the powder metal compact is removed after compaction before casting the liner into the cylinder wall.

7. A cylinder liner as in claim 1, wherein each piece has an average density in the range of 5.8-6.8 g/cm³.

8. A cylinder liner piece compact for making a cylinder liner as claimed in claim 1.

9. An engine including a cylinder liner made from at least two cylinder liner pieces as claimed in claim 1.

10. A cylinder liner, comprising at least two coaxial cylinder liner pieces placed end to end to make the liner, each said piece being made of a powder metal composition formed into a cylinder, said cylinder including a wall thickness and a length, a ratio of said length to said thickness of each piece being less than 20, said powder metal composition including approximately between 95% and 99% sponge iron powder, approximately between 0.1% and 2.0% graphite, and approximately between 0.1% and 2.0% of a lubricant.

11. The cylinder liner of claim 10, including approximately 98.1% said sponge iron powder, approximately 0.9% said graphite and approximately 1.0% said ethylene bis-stearamide wax.

12. The cylinder liner of claim 10, including up to 0.5% phosphorus.

13. The cylinder liner of claim 10, wherein a density of each piece is approximately between 5.8 g/cm³ and 6.8 g/cm³.

14. The cylinder liner of claim 13, wherein said density is approximately 6.3 g/cm³.

15. The cylinder liner of claim 10, wherein the wall thickness of a compact used to make each liner piece is less than approximately 0.20 inches.

16. An internal combustion engine, comprising:
an engine block including at least one combustion cylinder bore;
at least one cylinder liner, each said cylinder liner inserted into a corresponding said combustion cylinder bore, said cylinder liner including a powder metal composition, said cylinder liner including a wall thickness and a length, a ratio of said length to said thickness of said liner being greater than 12, each said liner being made of at least two coaxial cylinder liner pieces placed end to end, and each said liner piece having a length to wall thickness ratio of less than 20.

17. An internal combustion engine as in claim 16, wherein said powder metal composition includes approximately between 95% and 99% sponge iron powder, approximately between 0.1% and 2.0% graphite, and approximately between 0.1% and 2.0% ethylene bis-stearamide wax.
